(19) United States
(12) Patent Application Publication
(10) Pub. No.: US 2023/0411718 A1
(43) Pub. Date: Dec. 21, 2023

(54) ENERGY STORAGE SYSTEM

(71) Applicant: CERACOMB CO., LTD., Chungcheongnam-do (KR)

(72) Inventors: Kang Hong LEE, Cheonan-si (KR); Seung Ha NAM, Cheonan-si (KR); Dae Gyun KANG, Asan-si (KR); Byeong Seon SHIN, Cheonan-si (KR); Phil Won SEO, Asan-si (KR); Ji Sun KIM, Asan-si (KR); So Yeon KANG, Asan-si (KR)

(21) Appl. No.: 18/038,025

(22) PCT Filed: Jun. 14, 2021
(86) PCT No.: PCT/KR2021/007404

§ 371 Date: May 21, 2023

(30) Foreign Application Priority Data
Dec. 31, 2020 (KR) 10-2020-0189383

(51) Int. Cl. H01M 10/52; H01M 10/48; H01M 50/317

(52) U.S. Cl. CPC H01M 10/523; H01M 10/486; H01M 50/317

(57) ABSTRACT

The present invention provides an energy storage system comprising: at least one battery rack which comprises at least one battery pack; a container which accommodates the battery rack; and at least one catalytic structure which is located in the container, and in which hydrogen that has leaked from the battery pack reacts with a catalyst material and is recombined as steam.

### FIELD OF INVENTION

The present invention relates to an energy storage system, and more particularly, to an energy storage system capable of significantly reducing the risk of explosion by removing hydrogen leaked from a battery pack.

### BACKGROUND OF INVENTION

Currently, secondary batteries that can be repeatedly charged and discharged are commonly used in electric vehicles (EVs).

Such secondary batteries include a nickel cadmium battery, a nickel hydrogen battery, a nickel zinc battery, a lithium ion battery, and the like, and among them, the lithium ion battery has a very low self-discharge rate and a high energy density, and thus is mainly used.

Meanwhile, an energy storage system (ESS) refers to a system that is configured to store power supplied from the outside and then provide the stored power to the outside in an emergency.

The energy storage system may consist of a battery module and devices for managing the battery module. In this regard, such an energy storage system is not only a system for storing large-capacity power generated in a power plant, etc., but also may be a concept that encompasses all devices storing relatively low-capacity power such as a portable electronic device.

In the energy storage system, a battery pack may be constructed by connecting a plurality of battery cells in series and in parallel. Specifically, a battery module including at least one battery cell is configured first, and then a battery pack may be produced using the at least one battery module. The battery pack including at least one battery module constructs a battery rack by combining one or two or more of battery packs according to different voltage and capacity requirements, etc., and may be used to fabricate an energy storage system.

However, with regard to a battery device using such a secondary battery, hydrogen gas (H₂) may be generated when an electrolyte is gasified as the battery pack swells due to thermal factors, mechanical factors, electrical factors, design factors, public factors, etc., and such hydrogen gas may be easily ignited and exploded due to its strong flammability. Therefore, the demand for necessary technology to solve these problems is now increasing.

### SUMMARY OF INVENTION

### Technical Problem to be Solved

An object of the present invention is to provide an energy storage system capable of preventing an explosion, which may occur due to hydrogen's strong flammability, by removing hydrogen leaked from a battery pack.

### Technical Solution

In order to solve the above problems, the present invention provides an energy storage system, including: at least one battery rack which includes at least one battery pack; a container which accommodates the battery rack; and at least one catalyst structure which is located in the container so that hydrogen leaked from the battery pack reacts with a catalyst material to thus enable recombination into steam.

According to an embodiment, it may further include at least one discharge port formed on one side of the container in order to discharge the hydrogen leaked from the battery pack to the outside of the container, wherein the catalyst structure is located at the discharge port and may remove the hydrogen gas moving toward the discharge port.

According to an embodiment, it may further include a hydrogen discharge nozzle formed to protrude from the discharge port on the upper side of the container, which has a cross-sectional area smaller toward the discharge port side.

According to an embodiment, it may further include at least one fan provided at the discharge port in order to induce an ascending airflow with respect to the hydrogen in the container.

According to an embodiment, it may further include a hydrogen concentration measuring means located inside the container in order to measure a hydrogen gas concentration.

According to an embodiment, it may further include a control unit that drives the fan or increases a driving speed when the hydrogen gas concentration measured by the hydrogen concentration measuring means exceeds a preset threshold.

According to an embodiment, a hydrogen concentration distribution in the container in which the energy storage system is installed may be estimated using the learning information about the hydrogen concentration distribution in the container for the above containers having different shapes and sizes, wherein the energy storage system may further include a control unit for estimating the hydrogen concentration distribution in the corresponding container using the information outputted by substituting the learning information with data information on the container in which the energy storage system is provided, as well as location information of the hydrogen concentration measuring means in the container.

According to an embodiment, the catalyst structure may be formed in a cordierite honeycomb shape, and the cordierite honeycomb may be Pt/TiO₂ coated with platinum (Pt) as a catalyst support.

According to an embodiment, the cordierite honeycomb may have a number of cells per unit size of 10 to 900 cells per square inch (CPSI) and a web thickness of 2 to 12 mil.

According to an embodiment, it may further include: a non-contact temperature measuring means to measure a temperature of the surface of the catalyst structure using infrared rays; and a control unit that determines the removal of hydrogen gas by the catalyst structure when the temperature measured by the temperature measuring means increases, and varies external output depending on whether the catalyst structure is operated or not.

According to an embodiment, it may further include an alarm means that outputs an alarm when the increase in temperature measured by the temperature measuring means is greater than or equal to a preset variation of explosion threshold temperatures.

According to an embodiment, the control unit may take an arithmetic average of the change in temperatures measured for a predetermined period and compare the same with the explosion threshold temperature variation based on the arithmetic average result.

Further, the present invention may provide a battery rack including at least one battery pack, which further includes at least one catalyst structure located at one side of the battery rack, wherein hydrogen leaked from the battery pack reacts with a catalyst material so as to ensure recombination into steam.

According to an embodiment, it may further include a catalyst device, the catalyst device including: a main body having a gas inlet through which gas is introduced; a cover having a gas outlet through which the gas is discharged; and the catalyst structure which is accommodated in an inner space formed by the main body and the cover, wherein the catalyst device may be coupled to extend from an upper end of the battery rack.

### Effect of Invention

The energy storage system according to an embodiment of the present invention may prevent explosion possibly occurring due to hydrogen's strong flammability by removing hydrogen leaked from the battery pack.

Further, the energy storage system according to an embodiment of the present invention may determine whether the catalyst structure device for removing hydrogen is operating normally.

In addition, the energy storage system according to an embodiment of the present invention may alert the outside when a risk of hydrogen explosion is high, and furthermore, have effects of identifying a location with a high risk of hydrogen explosion by utilizing an artificial intelligence algorithm.

### BRIEF DESCRIPTION OF DRAWINGS

FIG. 1 illustrates the appearance of an energy storage system according to an embodiment of the present invention.

FIG. 2 illustrates the appearance of an energy storage system according to another embodiment of the present invention.

FIG. 3 illustrates a battery rack according to an embodiment of the present invention.

FIG. 4 is a schematic diagram of an energy storage system according to an embodiment of the present invention.

FIG. 5 illustrates a catalyst structure according to an embodiment of the present invention.

FIG. 6 is a block diagram of a hydrogen control system in the energy storage system according to an embodiment of the present invention.

FIG. 7 illustrates performance test results to space velocity when using a Pt/TiO2 catalyst coated on the cordierite honeycomb surface according to an embodiment of the present invention.

FIGS. 8a and 8b illustrate the appearance of a battery rack according to another embodiment of the present invention.

### DETAILED DESCRIPTION OF PREFERRED EMBODIMENTS OF INVENTION

Hereinafter, the embodiments disclosed in the present specification will be described in detail with reference to the accompanying drawings, but the same or similar components are assigned the same reference numbers regardless of reference numerals, and redundant description thereof will be omitted. The suffixes “module” and “part” for the components used in the following description are given or mixed in consideration of only the ease of writing the specification, however, do not have distinct meanings or roles by themselves. Further, in describing the embodiments disclosed in the present specification, if it is determined that detailed descriptions of related known technologies may obscure the gist of the embodiments disclosed in this specification, the detailed description thereof will be omitted. Further, the accompanying drawings are only for easy understanding of the embodiments disclosed in the present specification, and the technical idea disclosed herein is not limited by the accompanying drawings, and all changes included in the spirit and scope of the present invention should be understood to include equivalents or substitutes.

When an element is referred to as being “coupled” or “connected” to another element, it is understood that it may be directly coupled or connected to the other element, but other elements may also exist therebetween. On the other hand, when it is said that a certain element is “directly coupled” or “directly connected” to another element, it should be understood that other elements do not exist therebetween.

The singular expression includes the plural expression unless the context clearly dictates otherwise.

In this specification, terms such as “include” or “have” are intended to designate that the features, numbers, steps, operations, components, parts, or combinations thereof described in the specification exist, but it should be understood that it does not preclude the existence or addition of one or more other features, numbers, steps, operations, components, parts, or combinations thereof.

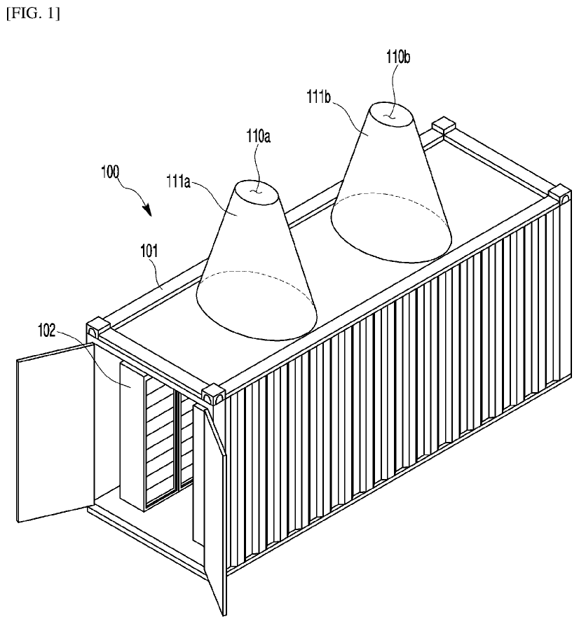

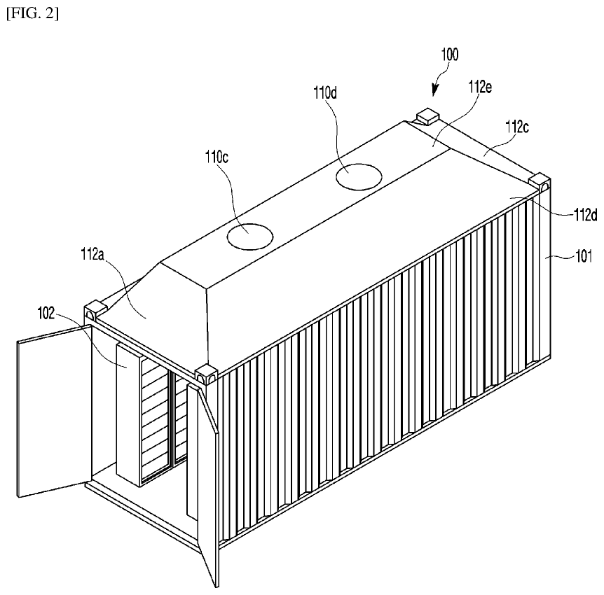

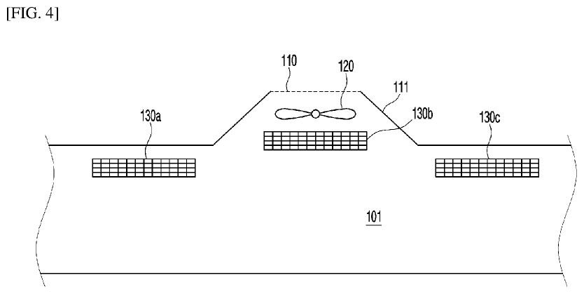

FIGS. 1 and 2 are views illustrating the appearance of an energy storage system according to an embodiment of the present invention, and FIG. 4 is a schematic diagram of an energy storage system according to an embodiment of the present invention.

As illustrated in FIGS. 1, 2 and 4, the energy storage system 100 according to an embodiment of the present invention may include: at least one battery rack 102 including at least one battery pack; a container 101 for accommodating the battery rack 102; and at least one catalyst structure 132a or 132b located in the container 101, in which hydrogen leaked from the battery pack reacts with a catalyst material to thus ensure recombination into steam.

However, when at least one discharge port 110 is formed on one side of the container 101 to discharge hydrogen leaked from the battery pack to the outside of the container 101, at least one catalyst structure 132a or 132b may be located at the discharge port 110 so that hydrogen moving to the discharge port 110 can react with a catalyst material.

Therefore, the energy storage system 100 according to an embodiment of the present invention may remove hydrogen leaked from the battery pack using the catalyst structures 132a and 132b provided in the container 101, thereby preventing damage due to hydrogen explosion in advance.

However, since the components shown in FIGS. 1, 2 and 4 are not essential, it goes without saying that an energy storage system having more or fewer components than the above may be implemented.

Hereinafter, these components will be described in detail.

The container 101, as having a space that can accommodate other components including the battery rack 102 therein, may be a box-shaped container used to transport cargo, as shown in the figures, but is not limited thereto and may be a building or the like.

By accommodating the battery rack 102 in the container 101, the battery rack 102 may not be exposed to the outside thereby primarily protecting the battery rack 102 from rain, wind, cold/warm weather, etc.

In this case, the container 101 may have an openable and closeable door on at least one side so that an operator can enter and exit the energy storage system 100 through the door.

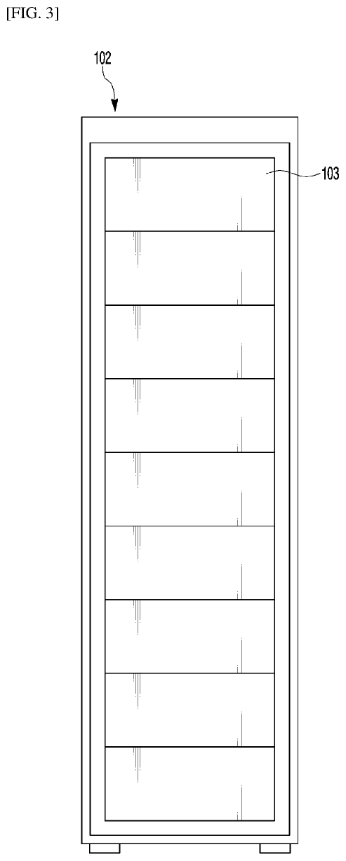

As described above, one or two or more battery racks 102 in which several battery modules 103 are loaded may be provided in an inner accommodating space of the container 101 (see FIG. 3).

The number and arrangement of the battery racks 102 in the container 101 are not particularly limited, but a plurality of battery racks 102 may be arranged side by side on both sides along a longitudinal direction of the container 101 with a passage in the middle of the same.

The plurality of battery modules 103 may be separately loaded according to the shape and location of the battery rack 102. A battery assembly may include at least one battery module 103, while the plurality of battery modules 103 may be connected in series or parallel through a connectable cable or the like.

The battery module 103 may be in a form in which a plurality of battery cells are assembled according to a required output voltage or capacity, wherein a unit battery cell is not particularly limited in terms of types, but may be a secondary battery such as a rechargeable lithium ion battery, lithium polymer battery, nickel cadmium battery, nickel hydrogen battery or nickel zinc battery, and the like.

Meanwhile, with regard to the container 101 according to an embodiment of the present invention, as shown in the figures, at least one discharge port 110 may be formed on one side, preferably an upper side, or either side of the container.

When flammable hydrogen leaks out of the battery pack due to various reasons, the light-weight hydrogen floats upward in the container 101. Accordingly, in order to easily discharge the hydrogen to the outside of the container 101, the container 101 may have an open discharge port 110 at the upper side thereof.

The number or size of the discharge ports 110 formed on the upper side of the container 101 is not particularly limited. However, according to a preferred embodiment, the discharge ports 110 are preferably provided in hydrogen discharge nozzles (111a and 111b, 112a to 112e), which are formed to protrude around the discharge ports 110 and have a cross-sectional area decreasing toward the discharge port sides 110.

In order to allow light-weight hydrogen to be concentrated in the discharge port 110 and rapidly discharged to the outside, the discharge port 110 is formed in the protruding hydrogen discharge nozzles (111a and 111b, 112a to 112e). In particular, according to a preferred embodiment as shown in FIG. 1, when the discharge port 110 has a small size, the discharge port 110 may be provided at the vertices of the substantially conical hydrogen discharge nozzles 111a and 111b.

According to another embodiment, the hydrogen discharge nozzles (111a and 111b, 112a to 112e) may have a shape protruding upward over the entire ceiling of the container 101, as shown in FIG. 2. That is, a plurality of sidewalls 112a to 112d are provided along the circumference of an upper plate 112e having at least one discharge port 110, wherein the sidewall may be inclined such that a cross-sectional area formed by the plurality of sidewalls 112a to 112d becomes narrower toward the discharge port side 110.

Hydrogen generated inside the container 101 may be concentrated toward the discharge port 110 by the plurality of inclined sidewalls 112a to 112d.

On the other hand, the energy storage system 100 according to an embodiment of the present invention may include at least one catalyst device 130 or catalyst structure 132a or 132b, which is located under the discharge port 110, wherein hydrogen moving to the discharge port 110 reacts with the catalyst material to thus ensure recombination into steam (H₂O). The catalyst device 130 or the catalyst structures 132a and 132b is a passive catalytic hydrogen-recombination device that does not use electric power, and may control a concentration of hydrogen in the container 101.

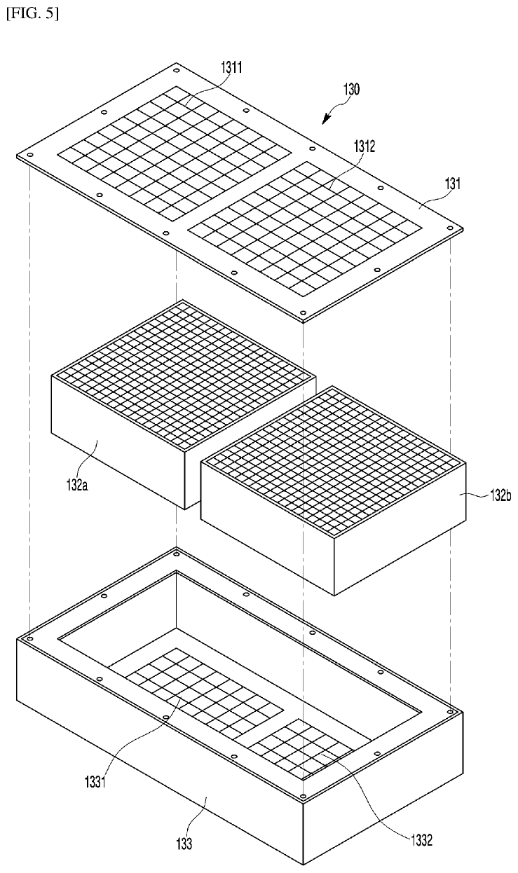

As shown in FIG. 5, the catalyst device 130 may include a main body 133 having gas inlets 1331 and 1332 through which gas is introduced, and a cover 131 having gas outlets 1311 and 1312 through which the gas is discharged; and the catalyst structures 132a and 132b which are accommodated in an inner space formed by the main body 133 and the cover 131. At this time, the cover 131 may be a mesh net made of a metal material having a predetermined size.

The catalyst device 130 is in contact with the hydrogen gas introduced through the gas inlets 1331 and 1332 to remove hydrogen via a catalytic reaction, while allowing steam or water (H₂O) to flow out to the gas outlets 1311 and 1312. Herein, the main body 133 and the cover 131 may be made of stainless steel having corrosion resistance so as not to be corroded by moisture.

The catalyst device 130 is brought into contact with a mixed gas containing hydrogen gas introduced from the outside, wherein hydrogen and oxygen of the mixed gas pass through the catalyst structures 132a and 132b to perform a recombination reaction into water (H₂O), thereafter, the mixed gas free of hydrogen may be discharged to the outside.

When hydrogen is bound with oxygen and thus converted into water in the catalyst structures 132a and 132b, natural convection occurs due to the generated heat and the mixed gas including hydrogen continuously passes through the body 133, so that hydrogen inside the container 101 can be continuously removed.

The catalyst structures 132a and 132b are recombination elements that combine hydrogen with oxygen in the introduced mixed gas to convert it into water, and may be fabricated by extrusion-molding of cordierite, which is a crystalline ceramic with a low coefficient of thermal expansion and excellent thermal shock resistance, into a honeycomb shape in consideration of the contact area with a reactant material, that is, hydrogen, as well as pressure loss.

At this time, the cordierite honeycomb, which is the catalyst structure 132a or 132b, has a number of cells per unit size of 10 to 900 CPSI (cells per square inch) and a web thickness of a wall partitioning individual cells may range from 2 to 12 mil, so that from low to high concentration of hydrogen can be processed. Further, the hydrogen having a concentration within the range of 0.1 to 8% contained in the mixed gas may be combined with oxygen to thus be converted into water.

However, the catalyst structures 132a and 132b according to an embodiment of the present invention are not limited thereto, and not only the cordierite honeycomb but also a metal honeycomb, and similarly, a structure in a net form that atypically has a plurality of empty spaces therein and can be coated with the catalyst, may be included.

According to an embodiment of the present invention, as a catalytic agent applied to the surface of the cordierite honeycomb, a Pt/TiO₂ catalytic agent may be prepared into a catalyst by a wet impregnation method, and the prepared catalyst may be applied to the cordierite honeycomb, thereby producing the catalyst structures 132a and 132b.

The catalyst applicable for coating the structure is illustrated as Pt/TiO₂, but the present invention is not limited thereto. Specifically, any one of platinum (Pt), palladium (Pd), ruthenium (Ru) and rhodium (Rh) or a combination thereof, or a metal oxide catalyst such as perovskite other than noble metals, as well as Al₂O₃, zeolite, SiO₂, La-r-Al₂O₃, graphene, carbon nanotubes, and the like as a catalyst support, may be included.

The mixed gas passing through the catalyst structures 132a and 132b may be formed within a temperature range of 0 to 300° C. Further, the mixed gas passing through the catalyst structures 132a and 132b may have a relative humidity of 95% or more.

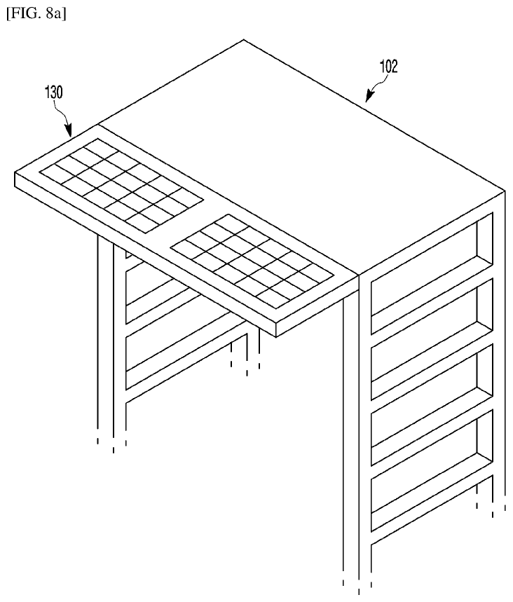

According to an embodiment, a performance test in relation to space velocity was implemented using the Pt/TiO₂ catalyst applied to the surface of the cordierite honeycomb as described above, and the results are shown in FIG. 7.

At this time, Al₂O₃ widely used as a catalyst support and TiO₂ used as a catalyst support of the present invention, respectively, are coated with platinum at 0.1% and 0.5% so as to prepare 0.1% Pt/TiO₂ and 0.5% Pt/TiO₂ as well as 0.1% Pt/Al₂O₃ and 0.5% Pt/Al₂O₃, respectively, which in turn were subjected to performance test in relation to space velocity at a space velocity of 3000 in the same manner.

As shown from the graph of FIG. 7, it could be seen that the Pt/TiO₂ catalyst has an increase in hydrogen removal capacity by about 40%, compared to Pt/Al₂O₃. Further, it could be seen that the Pt/TiO₂ catalyst has increased catalytic activity by 45 to 50% compared to Pt/Al₂O₃.

Therefore, in the case of a catalyst applied for hydrogen removal, it can be confirmed that TiO₂ may be an excellent catalyst support.

Meanwhile, FIG. 4 is a schematic diagram of an energy storage system according to an embodiment of the present invention.

As shown in FIG. 4, with regard to the energy storage system 100 according to an embodiment of the present invention, it may include a fan 120 provided at the discharge port 110 to induce an ascending airflow with respect to the hydrogen inside the container 101.

The fan 120 may be located above or below the discharge port 110 in order to discharge the gas inside the container 101 to the outside by driving the fan, and preferably, is interposed between the discharge port 110 and a catalyst device 130 located under the discharge port 110 so that the hydrogen-mixed gas may be introduced into the gas inlets 1311 and 1312 of the catalyst device 130 by driving the fan 120.

As described below, the fan 120 may be controlled on/off by a control command generated by a control unit 220, or a driving speed (or rotational speed) of the fan 120 may be adjusted.

The control unit 220 may continuously or periodically drive the fan 120 regardless of the concentration of hydrogen gas in the container 101. However, according to an embodiment of the present invention, when a preset threshold value is exceeded based on the hydrogen gas concentration in the container 101 measured by a hydrogen gas concentration measuring means 240, the control unit 220 may control the fan 120 to start driving or increase a driving speed so that the mixed gas containing hydrogen is forcibly induced to the discharge port 110 and the catalyst device 130 located under the same, whereby hydrogen can be quickly removed to thus reduce the possibility of spontaneous ignition due to high concentration hydrogen.

Further, as will be described later, by alerting the outside that hydrogen leakage has occurred in the container 101 through an alarm means 250, it is possible for the operator to take action quickly.

Herein, the hydrogen concentration measuring means 240 is located in the container 101 and is a means for measuring the hydrogen concentration around the installation location, and a detailed description thereof will be described later.

Meanwhile, as shown in FIG. 4, the catalyst device 130 may be provided at or around the discharge port 110, but the present invention is not limited thereto. In the case of the container 101 without a discharge port 110, the catalyst device may be provided on an inner upper side of the container 101 (see reference numerals 130a and 130c).

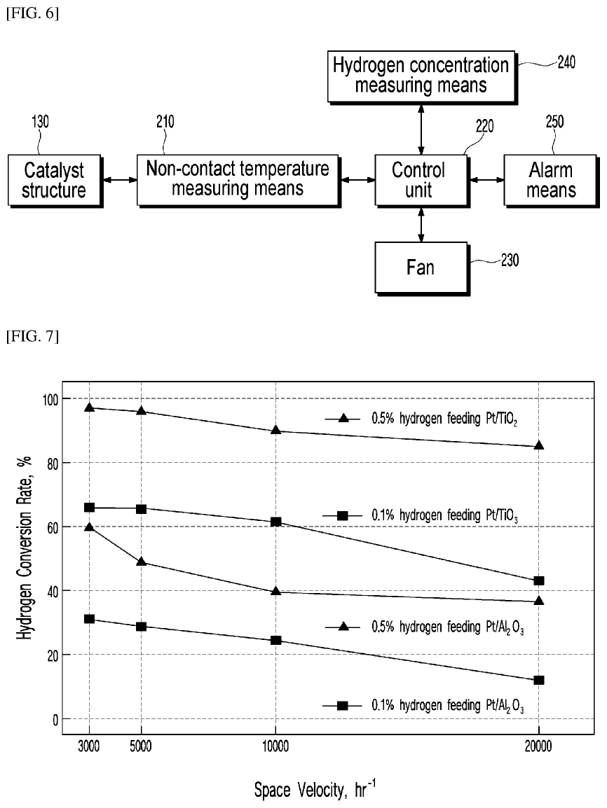

FIG. 6 is a block diagram of a hydrogen control system in the energy storage system according to an embodiment of the present invention.

As shown in FIG. 6, the energy storage system according to an embodiment of the present invention may include a non-contact temperature measuring means 210 for measuring a surface temperature of the catalyst structures 132a and 132b in a non-contact manner.

The non-contact temperature measuring means 210 according to an embodiment may be an infrared temperature sensor capable of measuring a temperature of an object to be measured (“measurement object”) using infrared rays. Specifically, the infrared temperature sensor may absorb energy radiated from the measurement object by a light receiving unit, convert the energy into thermal energy, and then convert a temperature rise into an electrical signal to thus detect the same. Such detection is based on the Stefan-Boltzmann law, and it is known that a magnitude of the electrical signal is proportional to the following Equation (1).

Tₒ⁴−Tₐ⁴ [Equation 1]

(wherein Tₒ is a surface temperature of the measurement object, and Tₐ is ambient temperature of the infrared sensor)

As described above, heat is generated when hydrogen in the mixed gas is converted into steam while combining with oxygen in the catalyst structures 132a and 132b, and the control unit 220 may use the temperature measuring means 210 to determine that, when heat is generated on the surface of the catalyst structures 132a and 132b to raise a temperature, hydrogen is being removed by the catalyst device 130 or the catalyst structures 132a and 132b during operation. That is, when the surface temperature of the catalyst structures 132a and 132b increases, the control unit 220 may determine that the catalyst structures 132a and 132b are removing hydrogen. On the other hand, when there is no temperature change, it may be determined that hydrogen is not being removed by the catalyst structures 132a and 132b.

At this time, when the temperature measuring means 210 is an infrared temperature sensor to measure a temperature of the measurement object using infrared rays, this is preferably installed to be spaced apart from the surface of the catalyst structures 132a and 132b rather than adjacent to the same, thereby improving measurement accuracy.

The controller 220 may output the above determined result visually using light or the like to the outside or may output audibly using sound, but the present invention does not specifically limit the output form.

However, it is preferable that the energy storage system 100 according to an embodiment of the present invention outputs an external output signal differently using the alarm means 250 depending on whether the catalyst device 130 is operated. Further, the operator may be alerted using the signal output from the alarm means 250 and, since this indicates a state in which hydrogen is leaking from the battery pack, it may motivate the operator to take a measure quickly in order to check whether the catalyst device 130 is in operation.

Meanwhile, although not shown in the drawings, the energy storage system 100 according to an embodiment of the present invention may include a wired/wireless communication unit (not shown), and the control unit 220 may use the communication unit and transmit the determined result whether the catalyst structures 132a and 132b are operated to a remote terminal.

In this regard, a communication method of the communication unit (not shown) is not particularly limited, but preferably uses a wireless communication mode such as WLAN (Wireless LAN), WiFi (Wireless Fidelity) Direct, DLNA (Digital Living Network Alliance), Wibro (Wireless broadband), Wimax (World Interoperability for Microwave Access), HSDPA (High Speed Downlink Packet Access), Bluetooth, RFID (Radio Frequency Identification), Infrared Data Association (IrDA), UWB (Ultra Wideband), ZigBee, NFC (Near Field Communication), LoRa (Long Range), and the like.

On the other hand, the control unit 220 according to an embodiment of the present invention may output alarm as another output way using the alarm means 250 if the temperature measured by the temperature measuring means 210 is greater than or equal to a preset explosion threshold temperature variation.

If high-concentration hydrogen exists inside the container 101, an increase in surface temperature of the catalyst structures 132a and 132b becomes larger. Therefore, the control unit 220 may predict a hydrogen concentration inside the container 101 using the above measured increase in temperature, even without any hydrogen concentration measuring means 240 to be described later.

Since there is a possibility of spontaneous ignition or spontaneous explosion when the hydrogen concentration is 4% or more, the control unit 220 according to an embodiment of the present invention may: compare a change in temperatures measured for a predetermined period of time using the temperature measuring means 210 with the preset explosion threshold temperature variation; and, if the increase in measured temperature is greater than or equal to the preset explosion threshold temperature variation, alert the risk of hydrogen explosion.

Further, the control unit 220 preferably generates a control command to operate the driving speed of all the fans 230 in the container 101 of the energy storage system 100 to the maximum, and induces the hydrogen concentration in the container 101 to be lowered, thereby preventing hydrogen explosion in advance.

However, if the temperature measured by the temperature measuring means 210 temporarily and sharply rises due to unknown and unclear causes and becomes greater than the preset explosion threshold temperature variation, an erroneous alarm may be notified. Hence, the control unit 220 according to an embodiment of the present invention stores a change history of the temperatures measured by the temperature measuring means 210 for a predetermined period of time, and may take arithmetic average or weighted average of the temperature change during the corresponding period, and then, preferably compare the temperature change with the preset explosion threshold temperature variation, based on the average value.

As such, according to an embodiment of the present invention, the control unit 220 may predict and notify in advance the spontaneous ignition and explosion due to an increase in hydrogen concentration in the container using the alarm means 250, thereby effectively preventing accidents due to hydrogen explosion.

On the other hand, the energy storage system 100 according to an embodiment of the present invention may further include a hydrogen concentration measuring means 240 in order to measure a hydrogen gas concentration around the installation location. Herein, the hydrogen concentration measuring means 240 is not particularly limited in terms of types so far as it is used for measuring a concentration of hydrogen gas in the air.

As described above, the energy storage system 100 according to an embodiment of the present invention may reduce the hydrogen concentration in the container 101 somewhat using the hydrogen concentration measuring means 240. However, it is very uneconomical to install a large volume of hydrogen concentration measuring means 240 at all positions in the container in a large area in order to prevent explosion caused by spontaneous explosion or the like due to a high concentration of hydrogen gas.

Therefore, the energy storage system 100 according to an embodiment of the present invention may store the learning information on the containers 101 with different shapes and sizes, in particular, regarding: where hydrogen gas at a high concentration is gathered when the hydrogen gas is generated at an arbitrary location in the container 101; that is, how the hydrogen gas concentrations are distributed. Further, the control unit 220 may use the information outputted by substituting the learning information with some parameters, in particular, the data information on the container 101 in which the corresponding energy storage system 100 is provided (e.g., the shape and size of the container 101), as well as the location information on a small volume of hydrogen concentration measuring means 240 installed in the container 101, and then, estimate a hydrogen concentration distribution in the corresponding container 101.

Therefore, even if the concentration of hydrogen gas measured by the hydrogen concentration measuring means 240 is not high, or even if the surface temperature rise of the catalyst structures 132a and 132b is not large, the control unit 220 may estimate the hydrogen concentration distribution in the corresponding container 101 of the energy storage system and, if a hydrogen concentration in any one position exceeds a preset threshold, may drive the fan 230 or increase a driving speed thereof to thus reduce the hydrogen concentration, in addition, may output alarm signals to the outside through the alarm means 250.

Of course, when the high concentration of hydrogen is predicted, the control unit 220 may generate a control command to operate the driving speed of all the fans 230 in the container 101 of the energy storage system 100 to the maximum, whereby it desirably induces rapid decrease of the hydrogen concentration inside the container 101.

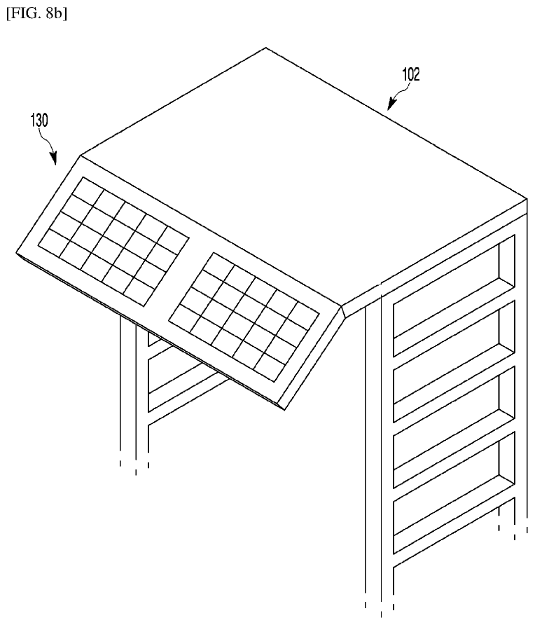

On the other hand, the catalyst structures 132a and 132b according to an embodiment of the present invention may be provided in the container 101, but may also be located at one side of the battery rack 102 (see FIGS. 8a and 8b).

As shown in FIG. 8a, the catalyst structure 132a or 132b or the catalyst device 130 including the same may be coupled to extend from one side of the battery rack 102, preferably from an upper end thereof, so that hydrogen gas leaked from a battery pack can be introduced into the catalyst structures 132a and 132b or the catalyst device 130.

At this time, the catalyst structure 132a or 132b or the catalyst device 130 may be configured such that any one edge thereof is coupled to the upper end of the battery rack 102 in a rotatable mode, whereby an operator can desirably adjust a coupling angle as needed.

As above, preferred embodiments of the present invention have been described in detail with reference to the drawings. The description of the present invention is for illustrative purposes, and those skilled in the art to which the present invention pertains will understand that it can be easily modified into other specific forms without changing the technical spirit or essential features of the present invention.

Accordingly, the scope of the present invention is indicated by the claims described later rather than the detailed description, and it should be interpreted that all changes or modifications derived from the meaning, scope, and equivalent concept of the claims are included in the scope of the present invention.

1. An energy storage system, comprising:
at least one battery rack which includes at least one battery pack;
a container which accommodates the battery rack; and
at least one catalyst structure which is located in the container so that hydrogen leaked from the battery pack reacts with a catalyst material to thus enable recombination into steam.

2. The energy storage system according to claim 1, further comprising:
at least one discharge port formed on one side of the container in order to discharge the hydrogen leaked from the battery pack to the outside of the container,
wherein the catalyst structure is located at the discharge port and removes the hydrogen gas moving toward the discharge port.

3. The energy storage system according to claim 2, further comprising:
a hydrogen discharge nozzle formed to protrude from the discharge port on the upper side of the container, which has a cross-sectional area smaller toward the discharge port side.

4. The energy storage system according to claim 2, further comprising:
at least one fan provided at the discharge port in order to induce an ascending airflow with respect to the hydrogen in the container.

5. The energy storage system according to claim 4, further comprising:
a hydrogen concentration measuring means located inside the container in order to measure a hydrogen gas concentration.

6. The energy storage system according to claim 5, further comprising:
a control unit that drives the fan or increases a driving speed thereof when the hydrogen gas concentration measured by the hydrogen concentration measuring means exceeds a preset threshold.

7. The energy storage system according to claim 5, wherein a hydrogen concentration distribution in the container, in which the energy storage system is installed, is estimated using the learning information on the hydrogen concentration distribution in the container for the above containers having different shapes and sizes,
wherein the energy storage system further comprises: a control unit for estimating the hydrogen concentration distribution in the corresponding container using the information outputted by substituting the learning information with the data information on the container in which the energy storage system is provided, as well as the location information of the hydrogen concentration measuring means in the container.

8. The energy storage system according to claim 1, wherein the catalyst structure is formed in a cordierite honeycomb shape, and the cordierite honeycomb is Pt/TiO₂ coated with platinum (Pt) as a catalyst support.

9. The energy storage system according to claim 8, wherein the cordierite honeycomb is formed to have a number of cells per unit size of 10 to 900 cells per square inch (CPSI) and a web thickness of 2 to 12 mil.

10. The energy storage system according to claim 1, further comprising:
a non-contact temperature measuring means to measure a temperature of the surface of the catalyst structure using infrared rays; and
a control unit that determines the removal of hydrogen gas by the catalyst structure when the temperature measured by the temperature measuring means increases, and varies external output depending on whether the catalyst structure is operated or not.

11. The energy storage system according to claim 10, further comprising:
an alarm means that outputs an alarm when an increase in temperature measured by the temperature measuring means is greater than or equal to a preset explosion threshold temperature variation.

12. The energy storage system according to claim 11, wherein the control unit takes an arithmetic average of the change in temperatures measured for a predetermined period and compares the same with the explosion threshold temperature variation based on the arithmetic average result.

13. A battery rack including at least one battery pack, further comprising:
at least one catalyst structure located at one side of the battery rack, wherein hydrogen leaked from the battery pack reacts with a catalyst material so as to ensure recombination into steam.

14. The battery rack according to claim 13, further comprising:
a catalyst device, including: a main body having a gas inlet through which gas is introduced;
a cover having a gas outlet through which the gas is discharged; and
the catalyst structure which is accommodated in an inner space formed by the main body and the cover,
wherein the catalyst device is coupled to extend from an upper end of the battery rack.
